(19) United States
(12) Patent Application Publication
(10) Pub. No.: US 2026/0191284 A1
(43) Pub. Date: Jul. 9, 2026

(54) WEARABLE MOIRÉ-BASED MECHANICAL STRAIN INDICATOR FOR OVERSTRETCH PREVENTION IN HIGH-MOBILITY PHYSICAL TRAINING

(71) Applicants: TETIANA VISHTAK, SAN ANTONIO, TX (US); SERHII NIKOLAICHUK, AUSTIN, TX (US)

(72) Inventors: TETIANA VISHTAK, SAN ANTONIO, TX (US); SERHII NIKOLAICHUK, AUSTIN, TX (US)

(21) Appl. No.: 19/561,148

(22) Filed: Mar. 9, 2026

(51) Int. Cl. A41D 27/08; A41D 13/00

(52) U.S. Cl. CPC A41D 27/08; A41D 13/0015; A41D 2600/10

(57) ABSTRACT

A passive, non-electronic wearable device (100) provides real-time visual biofeedback of soft tissue (130) elongation to prevent overstretch injuries. The device (100) comprises an elastic base layer (110) having a first periodic micro-pattern (112) and an elastic overlay layer (120) having a second periodic micro-pattern (122). The layers are superimposed and configured to elongate synchronously with the underlying soft tissue (130). When the soft tissue (130) reaches a predetermined biomechanical strain threshold, such as 22 to 34 percent elongation corresponding to a pre-pain safety limit, the relative geometric displacement between the first micro-pattern (112) and the second micro-pattern (122) generates a macroscopic Moiré interference pattern (140). This optical-mechanical interference visually exposes a hidden warning indicator (114) without requiring electronic components, power sources, or external sensors. The system can be integrated into athletic garments or worn as a standalone band.

### CROSS-REFERENCE TO RELATED APPLICATIONS

This application claims the benefit of and priority to U.S. Provisional Patent Application No. 63/973,216, filed on Jan. 31, 2026. The inventor of the referenced application is Tetiana Vishtak. The entire contents of the aforementioned provisional application are hereby incorporated by reference in their entirety.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### BACKGROUND OF THE INVENTION

### 1. Field of the Invention

The present invention relates generally to wearable biomechanical monitoring devices and smart textiles. More specifically, it relates to a passive, non-electronic mechanical strain indicator utilizing Moiré interference to provide real-time visual biofeedback for the prevention of soft tissue overstretch injuries during high-mobility physical training and rehabilitation.

### 2. Description of Related Art

In disciplines requiring extreme ranges of motion such as aerial arts, pole dance, rhythmic gymnastics, yoga, and flexibility-based rehabilitation athletes frequently experience overstretch injuries due to unreliable subjective pain perception. The fundamental cause of such injuries is often this disconnect, referred to as the “Perception Gap.”

During physical training, high adrenaline levels and elevated pain thresholds often mask early warning signs. Consequently, by the time pain is consciously registered by the user, the soft tissues may have already exceeded their safe limits, resulting in ligament laxity, muscle tears, and chronic injuries. Reinjury rates for common strains (e.g., hamstring) remain unacceptably high, reaching 30-63% within the first year.

The prior art contains various attempts at monitoring biomechanical strain. Traditional solutions predominantly rely on existing electronic monitoring devices (EMG, strain gauges, smart textiles). However, these systems have significant limitations that make them impractical for specific applications.

First, these electronic monitoring devices are expensive and require charging or depend on batteries. Second, they often rely on external interfaces (e.g., smartphones), which creates a delay between physical strain and the user's awareness. Third, rigid electronic components are often too rigid for extreme ROM required in high-mobility sports.

Therefore, there is a need for a simple, low-cost, passive, non-electronic wearable indicator. There is a critical need for a device that provides immediate objective visual biofeedback when soft tissue approaches its safe elongation limit, effectively protecting the user from injury without the use of fragile electronic components.

### BRIEF SUMMARY OF THE INVENTION

The present invention addresses the aforementioned problems of the prior art by providing a passive, non-electronic wearable device that utilizes mechanical Moiré interference to provide real-time visual biofeedback regarding soft tissue elongation. The device is designed to prevent overstretch injuries without the need for fragile components or those requiring a power source or charging.

At its core, the device comprises two superimposed elastic layers having calibrated periodic micro-patterns. The base layer contains a first periodic micro-pattern (e.g., a grating of parallel lines with a predetermined pitch). The overlay layer contains a second periodic micro-pattern having a slightly different pitch or angle.

A key novel principle of the invention is that the relative displacement of these layers, caused by the physical elongation of the underlying skin and soft tissues, generates a visible, high-contrast Moiré interference pattern (e.g., stripes, a grid, or a warning word such as “LIMIT”). This optical effect serves as an instantaneous visual signal.

To ensure medical and biomechanical accuracy, the device is calibrated such that the Moiré pattern becomes visible exclusively upon reaching a predetermined strain threshold. Specifically, the system is configured to activate when the skin and underlying soft tissues reach 75-85% of the user's current maximum safe range of motion (ROM), which corresponds to approximately 22-34% skin strain (elongation). This proactive alert enables the user to cease stretching prior to reaching the point of injury, thereby resolving the aforementioned “Perception Gap.”

Thus, the present invention provides immediate, objective biofeedback without the use of external sensors, electronic components, power sources, or batteries. The device operates solely through optical-mechanical interference, embodying the concept of “mechanical intelligence” wherein the textile structure itself measures and visualizes critical strain.

### BRIEF DESCRIPTION OF THE SEVERAL VIEWS OF THE DRAWINGS

The accompanying drawings, which are incorporated in and constitute a part of this specification, illustrate preferred embodiments of the invention and, together with the general description of the invention given above, and the detailed description given below, serve to explain the principles of the present invention.

FIG. 1 is a top plan view of the wearable device 100 in a relaxed state (0% strain), illustrating a neutral or masked appearance of the combined elastic base layer 110 and elastic overlay layer 120;

FIG. 2 is a top plan view of the wearable device 100 of FIG. 1 at a predetermined strain threshold (e.g., approximately 22-34% strain of the user's skin 130), illustrating the emergence of a visible Moiré interference pattern 140, such as a hidden warning indicator 114 (e.g., a “LIMIT” signal);

FIG. 3 is a schematic cross-sectional view of the layered structure of the wearable device 100, illustrating the spatial relationship between the elastic base layer 110, the first periodic micro-pattern 112, the elastic overlay layer 120, and the second periodic micro-pattern 122; and

FIG. 4 is a perspective environmental view of the wearable device 100 applied to a user's skin 130 (e.g., a thigh) during a dynamic stretch exercise, illustrating the practical application of the invention and the real-time visualization of the Moiré interference pattern 140.

### DETAILED DESCRIPTION OF THE INVENTION

The following is a detailed description of preferred embodiments of the present invention with reference to the accompanying drawings. These embodiments are described in sufficient detail to enable those skilled in the art to practice and use the invention. It is to be understood that other embodiments may be utilized, and that logical, mechanical, and optical changes may be made to the structure, materials, and physical parameters without departing from the spirit and scope of the present invention. Therefore, the following detailed description is not to be taken in a limiting sense.

### I. General Architecture and Layer Components

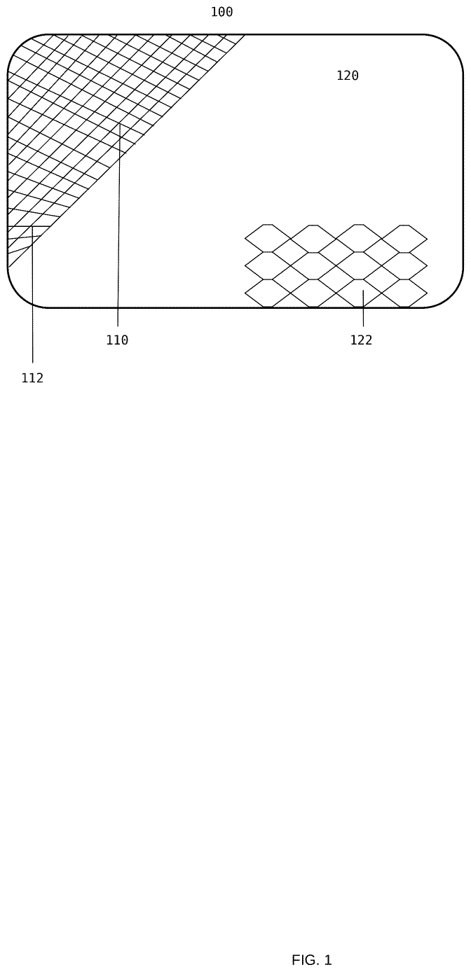

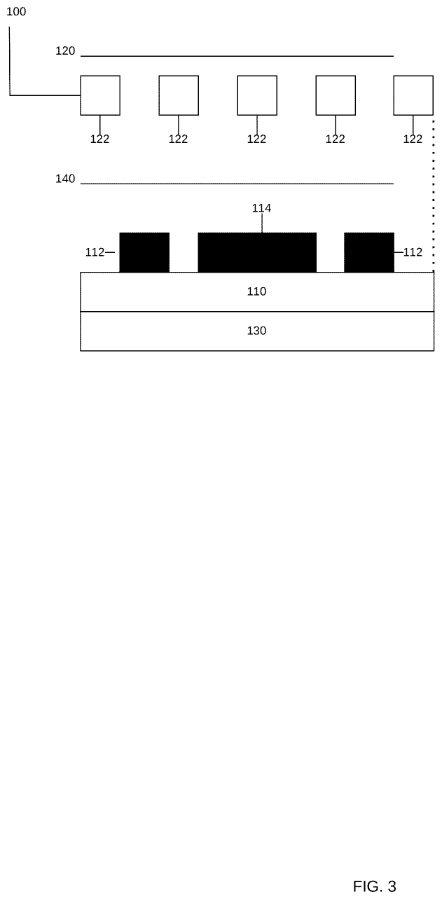

Referring to FIG. 1 and FIG. 3, the wearable device 100 generally comprises a multilayer textile or polymeric structure designed for direct or indirect contact with the user's skin 130. In its basic embodiment, the device 100 consists of an elastic base layer 110 (substrate) and an elastic overlay layer 120 superimposed on one another.

The elastic base layer 110 is made of a high-recovery material that stretches synchronously with the user's skin 130. An outward-facing surface (away from the user's body) of the base layer 110 is provided with a first periodic micro-pattern 112. In a preferred embodiment, the first micro-pattern 112 is an optical grating consisting of parallel lines, geometric shapes, or gradients having a predetermined initial pitch.

Furthermore, the first micro-pattern 112 may include or form a hidden warning indicator 114. This indicator 114 may be alphanumeric text (e.g., the word “LIMIT”, “STOP”, or “WARNING”), a pictogram, or a high-contrast color zone (e.g., neon magenta or bright red) that remains visually obscured by the overlay layer 120 in a relaxed state.

Positioned over the base layer 110 is the elastic overlay layer 120. The overlay layer 120 comprises a second periodic micro-pattern 122. In a preferred embodiment, the second micro-pattern 122 is configured as a hexagonal micro-grid (honeycomb structure) that acts as a mechanical optical shutter (iris diaphragm). The geometry of the grid cells is designed such that they remain optically closed or translucent in a relaxed state (0% strain), blocking visibility of the base layer 110.

The base layer 110 and the overlay layer 120 are structurally coupled to one another exclusively along anchoring boundaries or at specific discrete attachment points, leaving the central active zone free for relative sliding. This means that upon stretching of the device 100, the layers may deform at different rates or angles, thereby providing the necessary optical shift.

### II. Physics and Mechanism of Action

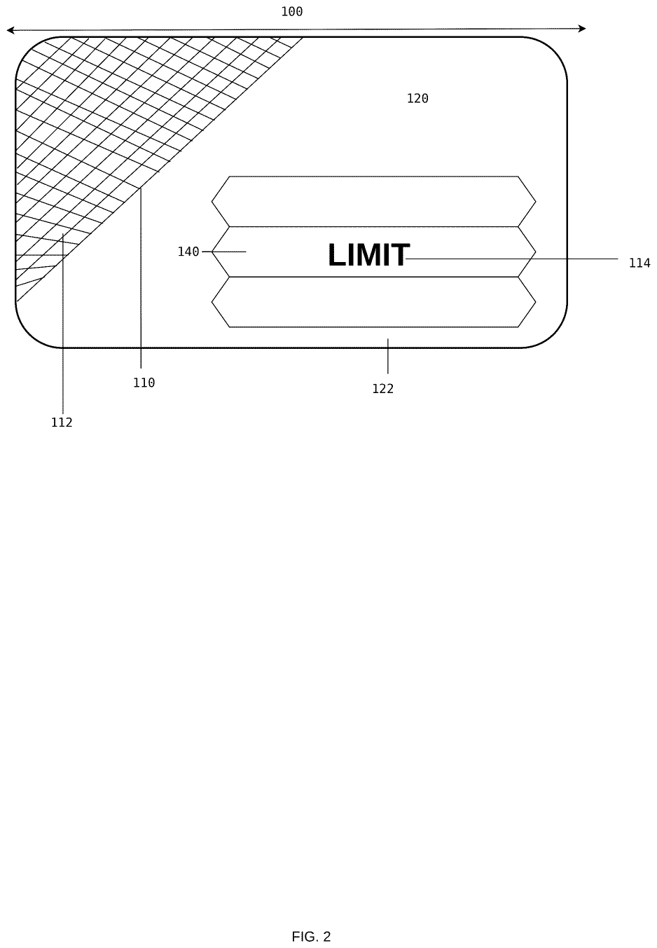

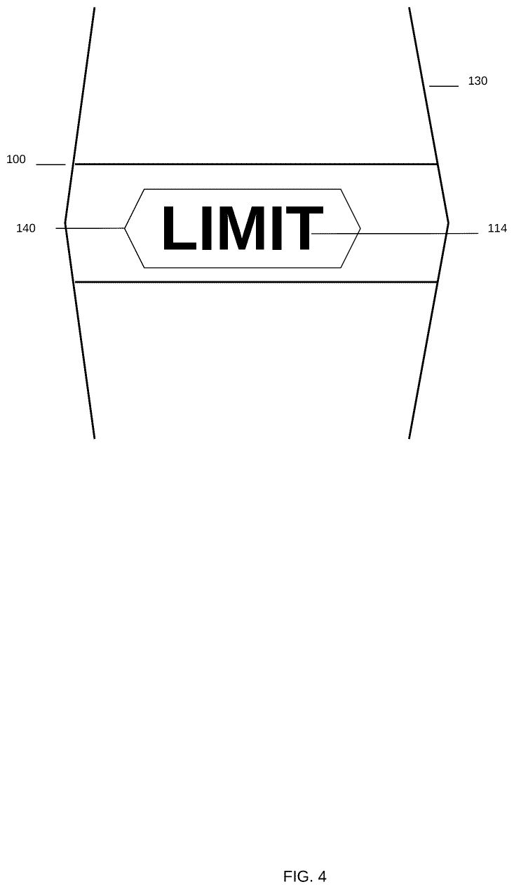

Referring to FIG. 2 and FIG. 4, the mechanism of action of the device 100 is based on the principles of physical optical interference known as the Moiré effect. The device functions as a passive, non-electronic sensor, entirely devoid of microprocessors, power sources, wires, or external data transmission interfaces.

Mathematically, when uniaxial or biaxial strain ε is applied to the device 100 (and consequently to the skin 130), where ε=ΔL/L, the pitch and geometry of the second micro-pattern 122 change. The relative displacement of the first micro-pattern 112 and the second micro-pattern 122 generates a macroscopic Moiré interference pattern 140. The Moiré fringe spacing is approximated by the formula Pm≈p/ε, where p is the initial grid pitch (preferably in the range of 0.4-0.8 mm) and ε is the relative strain.

A critical aspect of the present invention is the precision biomechanical calibration of said threshold. The device 100 is designed such that the Moiré interference pattern 140 and the hidden indicator 114 become visually discernible exclusively when the strain of the skin 130 reaches a predetermined calibration threshold in the range of 22% to 34% elongation.

This skin strain range (22-34%) empirically correlates to reaching 75-85% of the user's current maximum safe range of motion (ROM). Clinical studies demonstrate that exceeding the 85% ROM threshold is associated with an exponential increase in the risk of fascial microtrauma, ligament sprains, and muscle fiber tears. Thus, the device 100 provides proactive biofeedback prior to the onset of pain, neutralizing the so-called “Perception Gap” caused by the adrenaline-induced suppression of nociceptors (pain receptors) during physical training.

### III. Materials and Manufacturing Methods

To ensure the required anisotropy and durability, the elastic base layer 110 and the elastic overlay layer 120 are preferably manufactured from blended textile fibers containing a high percentage of elastane (e.g., 15% to 35%) combined with polyamide (nylon) or polyester. In alternative embodiments, the layers may be formed from ultra-thin thermoplastic polyurethane (TPU) films or medical-grade silicone elastomers. The overall thickness of the active working section of the device 100 preferably does not exceed 2.0 mm, providing a “second skin” effect.

The manufacturing of the device 100 involves high-tech processing methods without the use of electronics. The first micro-pattern 112 and the indicator 114 are preferably applied to the base layer 110 using high-resolution digital sublimation printing or screen printing with stretch-resistant silicone inks. The second micro-pattern 122 (hexagonal grid) is formed in the overlay layer 120 via precision laser etching or programmable jacquard weaving of fibers.

The bonding of layers 110 and 120 along the anchoring boundaries is accomplished using ultrasonic welding, thermal laser bonding, or elastic adhesives, which eliminates rigid seams that could distort the stretch mechanics.

### IV. Embodiments

In a first embodiment, illustrated in FIG. 4, the device 100 is configured as a standalone elastic band or wrap (e.g., a thigh band having a width of 10 to 15 cm) that is worn directly on the user's thigh, calf, or shoulder. This embodiment is optimal for isometric stretching and hamstring rehabilitation.

In a second embodiment, the device 100 is configured as an articulated orthosis, a knee wrap, or an elbow sleeve. In this configuration, the calibration of the micro-patterns 112 and 122 is adapted to specific joint biomechanics to prevent hyperextension.

In a third, highly integrated embodiment, the layers of the device 100 are incorporated directly into the architecture of full-scale athletic apparel, such as full compression leggings, yoga pants, gymnastics leotards, or wetsuits. In this scenario, layers 110 and 120 are integrated as seamless smart panels over critical muscle groups, providing comprehensive full-body biomechanical monitoring without adding weight to the gear.

It will be apparent to those skilled in the art that the described embodiments are provided as examples and do not limit the scope of the invention. The principles of passive mechanical intelligence based on the Moiré effect can be scaled to any type of wearable gear requiring strain monitoring.

What is claimed is:

1. A wearable biomechanical strain indicating device comprising: an elastic base layer configured to elongate synchronously with an underlying soft tissue, said base layer comprising a first periodic micro-pattern; and an elastic overlay layer superimposed over at least a portion of the elastic base layer, said overlay layer comprising a second periodic micro-pattern; wherein the base layer and the overlay layer are coupled to each other at one or more anchoring boundaries defining an active sliding zone therebetween; and wherein a uniaxial or biaxial elongation of the device reaching a predetermined strain threshold causes a relative geometric displacement between the first periodic micro-pattern and the second periodic micro-pattern within the active sliding zone, thereby generating a macroscopic Moiré interference pattern configured to provide a passive visual biofeedback signal.

2. The wearable biomechanical strain indicating device of claim 1, wherein the device is completely devoid of electronic components, microprocessors, power sources, and external data transmission interfaces.

3. The wearable biomechanical strain indicating device of claim 1, wherein the predetermined strain threshold is calibrated to correspond to approximately 22 percent to 34 percent elongation of the underlying soft tissue.

4. The wearable biomechanical strain indicating device of claim 3, wherein the 22 percent to 34 percent elongation corresponds to approximately 75 percent to 85 percent of a user's maximum safe range of motion.

5. The wearable biomechanical strain indicating device of claim 1, wherein the first periodic micro-pattern comprises a hidden warning indicator that remains visually obscured by the overlay layer when the device is at a zero percent strain state, and becomes visually exposed through the second periodic micro-pattern when the device reaches the predetermined strain threshold.

6. The wearable biomechanical strain indicating device of claim 5, wherein the hidden warning indicator comprises high-contrast alphanumeric text.

7. The wearable biomechanical strain indicating device of claim 1, wherein the second periodic micro-pattern comprises a hexagonal micro-grid configured to act as a mechanical optical shutter.

8. A method for providing real-time passive visual biofeedback to prevent soft tissue overstretch, the method comprising: applying a multilayer elastic device to a user's skin over a target soft tissue, the device comprising a base layer with a first micro-pattern and an overlay layer with a second micro-pattern; elongating the target soft tissue during a physical movement; and visually detecting a macroscopic Moiré interference pattern generated by a relative geometric displacement between the first micro-pattern and the second micro-pattern, wherein said Moiré interference pattern emerges exclusively when the target soft tissue reaches a predetermined biomechanical strain limit.

9. The method of claim 8, wherein the predetermined biomechanical strain limit is calibrated to approximately 22 percent to 34 percent skin strain, corresponding to a pre-pain threshold of the user.

10. An athletic garment incorporating a passive mechanical strain indicating system, comprising: a primary garment body formed of a stretchable textile; and at least one strain-indicating panel integrated into the primary garment body and positioned to align with a critical muscle group, said strain-indicating panel comprising: a substrate layer having a first periodic micro-pattern including a warning indicator; and an overlay layer having a second periodic micro-pattern configured as an optical grating; wherein a physical elongation of the critical muscle group beyond a safe threshold mechanically alters a pitch of the optical grating, thereby exposing the warning indicator through a Moiré interference effect without the use of electronic sensors.
